(19) United States
(12) Patent Application Publication
(10) Pub. No.: US 2025/0215713 A1
(43) Pub. Date: Jul. 3, 2025

(54) METHOD OF CONSTRUCTING INNER WALL OF MODULAR HOUSE

(71) Applicant: Myung Hwan KIM, Goyang-si, Gyeonggi-do (KR)

(72) Inventor: Myung Hwan KIM, Goyang-si, Gyeonggi-do (KR)

(21) Appl. No.: 18/851,054

(22) PCT Filed: Mar. 29, 2023
(86) PCT No.: PCT/KR2023/004205

§ 371 Date: Sep. 25, 2024

(30) Foreign Application Priority Data
Mar. 31, 2022 (KR) 10-2022-0040819

(51) Int. Cl. E04H 1/12; B44C 7/02; C09D 5/18; C09D 7/45; C09D 7/63; C09D 161/06

(52) U.S. Cl. CPC E04H 1/1205; B44C 7/02; C09D 5/18; C09D 7/45; C09D 7/63; C09D 161/06; E04H 2001/1283

(57) ABSTRACT

The present invention relates to a method for constructing an inner wall of a modular house, the method comprising the steps of: (A) installing a temporary inner wall inside a container frame; (B) filling and curing a heat-insulating foamed resin between the wall structure of the container framework and the temporary inner wall; and (C) moving the temporary inner wall along the wall structure of the container framework and then repeating steps (A) and (B).

### TECHNICAL FIELD

The present invention relates to a method of constructing an inner wall of a modular house, and more specifically, to a method of constructing an inner wall of a modular house to improve constructability, shorten a construction period, and reduce construction costs by continuously installing an insulation material for insulation and wallpapering over the entire inner wall in one process when an inner wall of the modular house is constructed.

Background Art

A container house is a type of ready-made temporary building that is manufactured in a factory and installed at a desired site. Unlike conventional temporary buildings manufactured with conventional sandwich panels, the container houses can be installed more quickly than conventional buildings and can be moved from one place to another after use.

Such container houses were previously mainly used as offices, accommodations, and the like at construction sites, but are increasingly being used as temporary accommodations at tourist destinations, as well as temporary accommodations for residents who need a place to reside until construction is completed, and as dormitories for schools.

Therefore, recently, container houses with luxurious exteriors and interiors similar to those of standard residential buildings have been produced. These container houses are widely used as suitable regular accommodations due to their differentiated designs from conventional standardized container houses.

When constructing the inner walls of such container houses, it is common to first install insulation materials, such as Styrofoam, inside the framework of the container house and then to wallpaper over the insulation materials.

In this case, since the installation of insulation materials and wallpapering work should be performed separately, the construction period is prolonged. Additionally, since separate labor is required for installing insulation materials and wallpapering, construction costs increase.

Particularly, due to the recent outbreak of COVID-19, there has been an explosive increase in demand for container houses to be used as clinics and accommodations for quarantined patients. However, the above-mentioned conventional methods could not respond to this explosive increase in demand.

### DISCLOSURE

### Technical Problem

The present invention is directed to providing a method of constructing an inner wall of a modular house to improve constructability and shorten a construction period.

The present invention is directed to providing a method of constructing an inner wall of a modular house to reduce the manufacturing costs of a modular house by minimizing construction costs.

### Technical Solution

One aspect of the present invention provides a method of constructing an inner wall of a modular house with a rectangular parallelepiped exterior. The method includes step (A) of installing a temporary inner wall in a container framework, step (B) of filling a space between a wall of the container framework and the temporary inner wall with a heat-insulating foamed resin and curing the heat-insulating foamed resin, and step (C) of moving the temporary inner wall along the wall of the container framework and repeating steps (A) and (B).

The container framework, which is formed with an additional opening for access and lighting in a standardized container box, may include a quadrangular floor, a quadrangular ceiling facing the floor, and side walls vertically connecting the floor and the ceiling.

The temporary inner wall, which is installed at a predetermined distance from the ceiling and the side walls when installed in the container framework, may include a top plate formed shorter than a width of the ceiling by a predetermined length, a pair of side plates formed downward from an end of the top plate to face a longitudinal side wall and formed shorter than a height of the longitudinal side wall by a predetermined length, and a finishing plate which finishes one end of a structure formed by the top plate and the pair of side plates.

Each of the top plate, the side plates, and the finishing plate may include a plurality of rectangular connecting pieces, and the plurality of rectangular connecting pieces may be foldably connected by a rotating shaft installed between the adjacent connecting pieces.

Each of the top plate, the side plates, and the finishing plate may include a plurality of rectangular connecting pieces, and the plurality of rectangular connecting pieces may have insertion protrusions formed at one longitudinal face thereof and insertion grooves formed at the other face, allowing the plurality of rectangular connecting pieces to be inserted and connected to each other.

Step (A) may include step (A1) of constructing a temporary inner wall in a constructed form in the container framework using the connecting pieces, step (A2) of bringing wallpaper into close contact with an outer surface of the temporary inner wall, and step (A3) of moving the temporary inner wall to a construction position.

Each of the top plate, the side plates, and the finishing plate may include an adsorption hole for adsorbing the wallpaper.

Step (A2) may include step (A21) of placing wallpaper on the top plate, the side plates, and the finishing plate, step (A22) of connecting an air pump to the adsorption hole and adsorbing the wallpaper onto the top plate, the side plates, and the finishing plate, step (A23) of maintaining the adsorption state while filling the heat-insulating foamed resin in step (B), and step (A24) of stopping operation of the air pump after step (B).

Also, during the filling with the heat-insulating foamed resin in step (B), the adsorption state of the wallpaper may be maintained, and the operation of the air pump may be stopped after the curing of the heat-insulating foamed resin. However, during the curing of the heat-insulating foamed resin in step (B), the negative pressure of the air pump may be sequentially varied and adjusted to a positive pressure corresponding to the expansion pressure of the heat-insulating foamed resin.

Step (B) may include step (B1) of positioning pipes for filling one ends between the side walls and the ceiling of the container framework and the wallpaper with a heat-insulating foamed resin, step (B2) of filling a space between the side walls and the ceiling of the container framework and the wallpaper with the heat-insulating foamed resin while moving the pipe for filling a heat-insulating foamed resin from the one end to the other end, and step (B3) of curing the heat-insulating foamed resin for a predetermined time after the filling is completed.

The heat-insulating foamed resin may be composed of 20 to 50% by weight of a phenolic resin, 1 to 10% by weight of a surfactant, 10 to 40% by weight of a melamine compound, 0.1 to 5% by weight of a foaming accelerator, 20 to 40% by weight of a flame retardant, and 10 to 20% by weight of a solvent.

The flame retardant may include a halogenated flame retardant.

The upper plate and the side plates may be installed at a distance of 5 to 15 cm from the ceiling and the longitudinal side walls.

Step (A) may further include, before moving the temporary inner wall to a construction position in step (A3), installing a filling prevention frame that corresponds to an outer edge of the opening and prevents the opening from being filled with the heat-insulating foamed resin.

When the filling prevention frame is installed, strip-shaped wallpaper for finishing an edge portion of the opening may be attached to an outer edge surface of the filling prevention frame to prevent the filling prevention frame from being in contact with the heat-insulating foamed resin so that separation of the filling prevention frame is easy.

A guide groove for cutting the wallpaper may be formed in a front surface of the filling prevention frame.

### Advantageous Effects

In a method of constructing an inner wall of a modular house according to the present invention, a temporary inner wall is installed adjacent to the inner side of the container framework wall, and after wallpaper is brought into close contact with the temporary inner wall, a heat-insulating foamed resin is injected and cured between the container framework wall and the temporary inner wall to simultaneously perform the installation of the insulation material and wallpapering, thereby improving construction efficiency and reducing the construction period.

Additionally, according to the present invention, unlike conventional methods in which separate labor was required for insulation installation and wallpapering, the present invention allows insulation installation and wallpapering to be performed by the same workers, thereby minimizing construction costs.

Furthermore, in the present invention, an inner wall with a quick and high-quality finish can be provided by using foldable or prefabricated temporary walls and wallpaper that is adsorbed by air pressure.

Moreover, according to the present invention, since a construction period is remarkably reduced, the urgent demand for container houses, such as accommodations for COVID-19 quarantined patients, can be managed effectively.

### DESCRIPTION OF DRAWINGS

FIG. 1 is a block diagram illustrating a sequence of a method of constructing an inner wall of a modular house according to the present invention.

FIG. 2 is a perspective view of the modular house used in the construction method of the present invention.

FIG. 3 is a perspective view schematically illustrating a framework and a temporary inner wall of the modular house to explain the construction method according to the present invention.

FIG. 4 is a cross-sectional view illustrating the framework and the temporary inner wall of the modular house according to the present invention.

FIG. 5 is a perspective view of the temporary inner wall according to the present invention.

FIG. 6 is a perspective view of a connecting piece that constitutes the temporary inner wall according to the present invention.

FIG. 7 is a perspective view illustrating a state in which adsorption holes are formed in the temporary inner wall according to the present invention.

FIG. 8 is a perspective view of a filling prevention frame according to the present invention.

### BEST MODES OF THE INVENTION

According to embodiments of the present invention, the method of constructing an inner wall of a modular house with a rectangular parallelepiped exterior, the method including step (A) of installing a temporary inner wall in a container framework, step (B) of filling a gap between a wall of the container framework and the temporary inner wall with a heat-insulating foamed resin and curing the heat-insulating foamed resin, and step (C) of moving the temporary inner wall along the wall of the container framework and repeating steps (A) and (B). The container framework is formed with an additional opening for access and lighting in a standardized container box, and includes a quadrangular floor, a quadrangular ceiling facing the floor, and side walls vertically connecting the floor and the ceiling. The temporary inner wall is installed at a predetermined distance from the ceiling and the side walls when installed in the container framework, and includes a top plate formed shorter than a width of the ceiling by a predetermined length, a pair of side plates formed downward from an end of the top plate to face a longitudinal side wall and formed shorter than a height of the longitudinal side wall by a predetermined length, and a finishing plate which finishes one end of a structure formed by the top plate and the pair of side plates.

### [Modes of the Invention]

Exemplary embodiments of the present invention will be illustrated in the drawings and described in detail, but the embodiments may be changed and have many alternative forms. However, the present invention is not limited to specific embodiments, and it should be appreciated that the present invention includes all changes, equivalents, and substitutes included in the spirit and technical scope of embodiments. In the description of embodiments of the present invention, when it is determined that a specific detailed description of the related art may obscure the gist of the present invention, the detailed description thereof will be omitted.

It should be understood that, although the terms “first,” “second,” etc. may be used herein to describe various elements, these elements are not limited by the terms. The terms are only used to distinguish one element from another.

The terms used herein are for the purpose of describing particular embodiments only and are not intended to limit the invention. As used herein, the singular forms are intended to include the plural forms as well, unless the context clearly indicates otherwise. It should be further understood that the terms “comprise,” “comprising,” “include” and/or “including” used herein specify the presence of stated features, integers, steps, operations, elements, and/or components, but do not preclude the presence or addition of one or more other features, integers, steps, operations, elements, components, and/or groups thereof.

The present invention relates to a method of constructing an inner wall of a modular house to improve construability, shorten a construction period, and reduce construction costs by simultaneously installing insulation materials for insulation and wallpapering when an inner wall of a modular house is constructed.

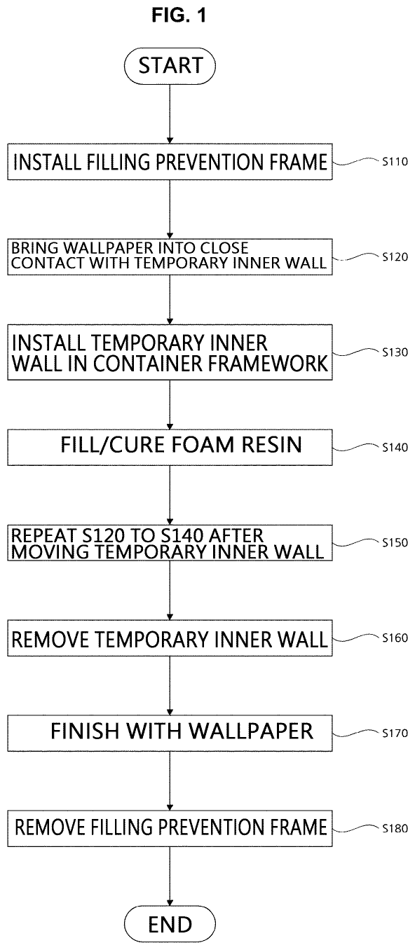

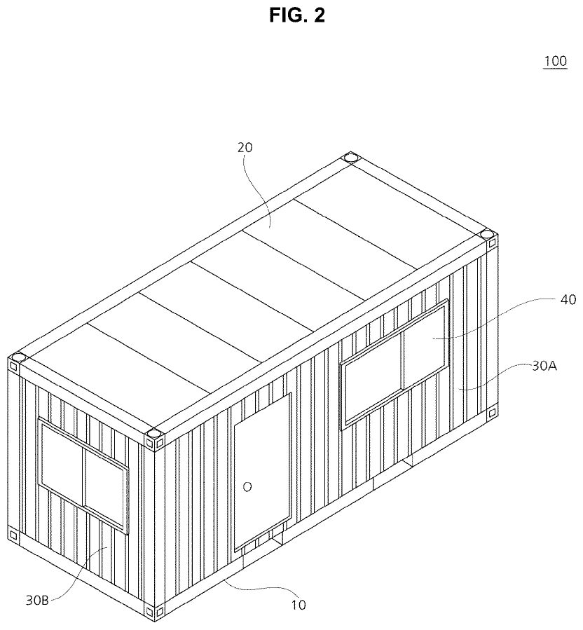

Hereinafter, the method of constructing an inner wall of a modular house according to the present invention will be described in more detail with reference to exemplary embodiments and the accompanying drawings. In this regard, FIG. 1 is a block diagram illustrating the sequence of the method of constructing an inner wall of a modular house according to the present invention, and FIG. 2 is a perspective view of the modular house used in the construction method of the present invention.

First, referring to FIGS. 1 to 2, the method of constructing an inner wall of a modular house according to the present invention may include (A) installing a temporary inner wall inside a framework of a container, (B) filling a space between a wall of the container framework and the temporary inner wall with a heat-insulating foamed resin and curing the heat-insulating foamed resin, and (C) moving the temporary inner wall along a wall of the framework of a container and repeating steps (A) and (B).

The modular house according to the present invention is constructed based on a container framework 100 with a rectangular parallelepiped exterior, and the container framework 100 is manufactured in a standardized form at a factory and then transported by a large truck and installed on a site.

Openings 40 for access and lighting are additionally installed in the container framework 100, and a space for the installation of various facilities for living or working may be provided inside the container framework 100.

To explain this in more detail, the container framework 100 may include a quadrangular floor 10, a quadrangular ceiling 20 facing the floor 10, and side walls 30A and 30B vertically connected between the floor 10 and the ceiling 20. Also, the side walls 30A and 30B may include openings 40 for the installation of a door, a window, or the like.

The container framework 100 may be securely fixed to the ground by a plurality of piles (not shown) which pass through corners of the container framework 100 and are driven into the ground. Also, the modular house according to the present invention may include not only residential houses but also, for example, cargo transport containers.

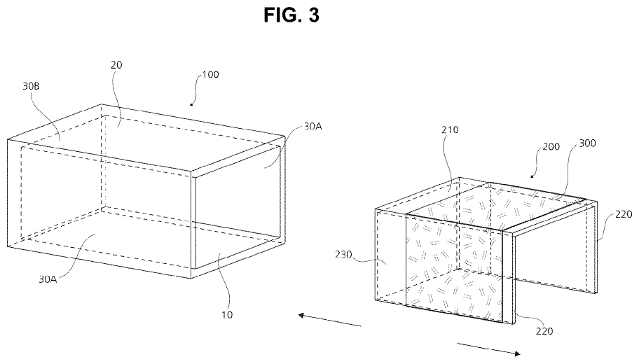

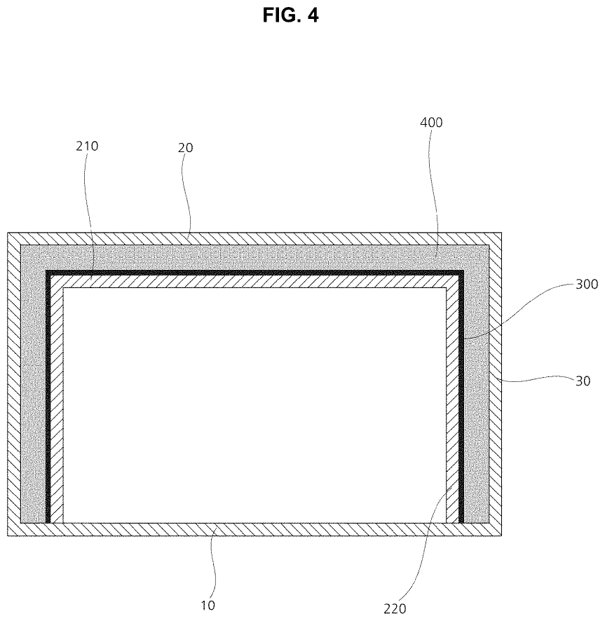

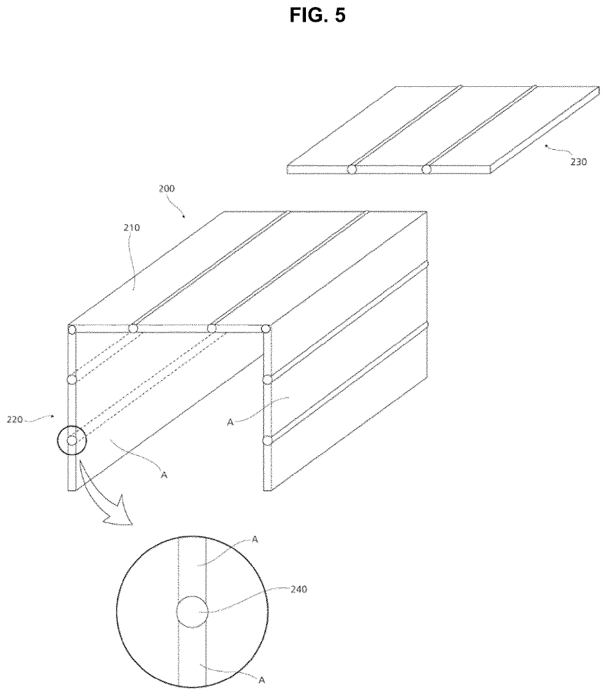

Meanwhile, FIG. 3 is a perspective view schematically illustrating a container framework 100 and a temporary inner wall 200 to describe the method of constructing an inner wall of a modular house according to the present invention, FIG. 4 is a cross-sectional view illustrating the container framework 100 and the temporary inner wall 200, and FIG. 5 is a detailed perspective view of the temporary inner wall 200.

Referring to FIGS. 3 to 5, the temporary inner wall 200 may be installed at a predetermined distance from the ceiling 20 and the side walls 30A and 30B when installed inside the container framework 100.

To this end, the temporary inner wall 200 may include a top plate 210, which is formed shorter than the width of the ceiling 20 of the container framework 100 by a predetermined length, a pair of side plates 220, which are formed downward from an end of the top plate 210, face the longitudinal side walls 30A of the container framework 100, and are formed shorter than the height of the longitudinal side walls 30A of the container framework 100, and a finishing plate 230, which finishes one end of a structure formed by the top plate 210 and the pair of side plates 220.

Therefore, when the top plate 210 and the pair of side plates 220 are assembled, the top plate 210 and the pair of side plates 220 may be installed at a predetermined distance from the ceiling 20 and the side walls 30A and 30B in the container framework 100.

Meanwhile, since the temporary inner wall 200 should be installed at a predetermined distance from the ceiling 20 and the side walls 30A and 30B of the container framework 100, there is a concern that the assembled temporary inner wall 200 is too large and does not pass through a door of the container framework 100.

Therefore, according to the present invention, each of the top plate 210, the side plates 220, and the finishing plate 230 includes a plurality of rectangular connecting pieces A, and the plurality of rectangular connecting pieces A may be foldably connected through a rotating shaft 240 installed between adjacent connecting pieces A.

Thus, after the temporary inner wall 200 passes through the door of the container framework 100 while the connecting pieces A are folded, the temporary inner wall 200 is unfolded and then installed in the container framework 100.

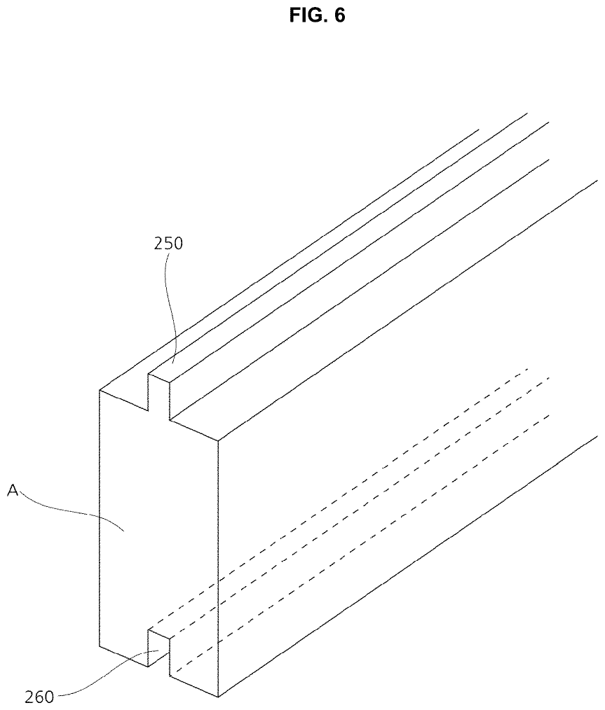

FIG. 6 is a perspective view of another example of the connecting piece A. Referring to FIG. 6, each of the plurality of rectangular connecting pieces A includes insertion protrusion 250 formed on one side face thereof in a longitudinal direction and an insertion groove 260 formed in the other side face such that the plurality of rectangular connecting pieces A are inserted and connected to each other.

According to the present embodiment, the connecting pieces A are stored and transported in a disassembled state. The connecting pieces A are brought into the container framework 100 and assembled to install the temporary inner wall 200.

Hereinafter, the method of constructing an inner wall of a modular house of the present invention will be described step by step in accordance with the construction sequence with reference to FIG. 1 again.

### Step of Forming a Temporary Inner Wall 200 in a Constructed Form Using the Connecting Pieces a in the Container Framework 100

First, as described above, the folded connecting pieces A or the separate connecting pieces A are brought into the container framework 100, and then the temporary inner wall 200 is installed at a predetermined distance from the ceiling 20 and the side walls 30A and 30B of the container framework 100.

Step of Bringing Wallpaper into Close Contact with an Outer Surface of the Temporary Inner Wall 200

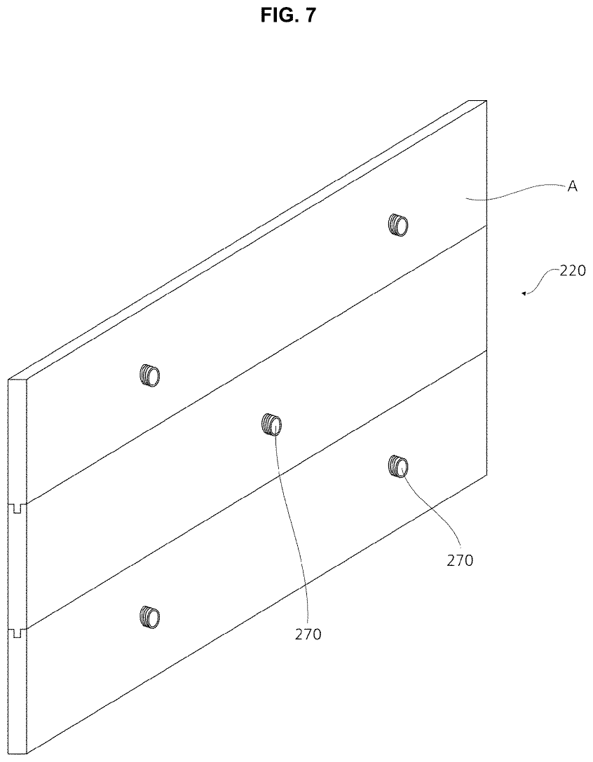

Next, wallpaper 300 is brought into close contact with the top plate 210, the side plates 220, and the finishing plate 230 of the temporary inner wall 200, adsorption holes 270 for adsorbing the wallpaper 300 are formed in the top plate 210, the side plates 220, and the finishing plate 230 as shown in FIG. 7.

To explain this in more detail, first, the wallpaper 300 is placed on the top plate 210, the side plates 220, and the finishing plate 230. Then, an air pump (not shown) is connected to the adsorption holes 270, and the wallpaper 300 is adsorbed onto the top plate 210, the side plates 220, and the finishing plate 230.

That is, when the air pump is operated, a negative pressure is maintained through the adsorption holes 270, and thus the wallpaper 300 is brought into close contact with the top plate 210, the side plates 220, and the finishing plate 230.

### Step of Filling and Curing Heat-Insulating Foamed Resin 400

As described above, when the wallpaper 300 is brought into close contact with the temporary inner wall 200, a heat-insulating foamed resin-filling pipe (not shown) is positioned at one end between the side walls 30A and 30B and the ceiling 20 of the container framework 100 and the wallpaper 300. Then, the space between the side walls 30A and 30B and the ceiling 20 of the container framework 100 and the wallpaper 300 is filled with the heat-insulating foamed resin 400 while the heat-insulating foamed resin-filling pipe moves from the one end to the other.

In this case, the adsorption state is maintained while filling the heat-insulating foamed resin 400 so that the wallpaper 300 is kept in close contact with the temporary inner wall 200.

Meanwhile, in the step of curing the heat-insulating foamed resin 400, since the heat-insulating foamed resin 400 expands such that an expansion pressure acts on the wallpaper 300, there is a concern that a portion of the wallpaper 300 at which the adsorption holes 270 are formed may protrude outward.

Therefore, according to the present invention, while curing the heat-insulating foamed resin 400, the negative pressure of the air pump is sequentially varied and adjusted to a positive pressure which corresponds to the expansion pressure of the heat-insulating foamed resin 400, thereby enabling the above problem to be solved.

In the present invention, the heat-insulating foamed resin 400 may contain 20 to 50% by weight of a phenolic resin, 1 to 10% by weight of a surfactant, 10 to 40% by weight of a melamine compound, 0.1 to 5% by weight of a foaming accelerator, 20 to 40% by weight of a flame retardant, and 10 to 20% by weight of a solvent.

In this case, the flame retardant may include a halogenated flame retardant but is not limited thereto. The halogenated flame retardant may include bromine (Br)-based or fluorine (F)-based flame retardants.

Also, the phenolic resin may have a viscosity of 4,000 to 25,000 cps at a temperature of 25° C. and a moisture content of 2 to 12%. In addition, the surfactant may be a non-ionic surfactant or a silicone-based surfactant.

In the prevent invention, the temporary inner wall 200 may be installed at a distance of 5 cm to 15 cm from the side walls 30A and 30B and the ceiling 20 of the container framework 100. When the temporary inner wall 200 is spaced less than 5 cm from the side walls 30A and 30B and the ceiling 20 of the container framework 100, the insulation effect may be insignificant. When the distance exceeds 15 cm, excessive construction and a reduction in interior space may occur.

Step of Moving the Temporary Inner Wall 200 Along a Wall of the Container Framework 100 and then Repeating the Above-Described Processes

When the curing of the heat-insulating foamed resin 400 is completed as described above, the temporary inner wall 200 is moved along the longitudinal side wall 30A of the container framework 100, the wallpaper 300 is brought into close contact with the temporary inner wall 200, and then the step of filling and curing the heat-insulating foamed resin 400 is performed in the same manner as previously described.

### Step of Installing a Filling Prevention Frame

Meanwhile, as described above, the openings 40 for access, lighting, and ventilation are formed in the container framework 100, so there is a need to prevent these openings 40 from being filled with the heat-insulating foamed resin.

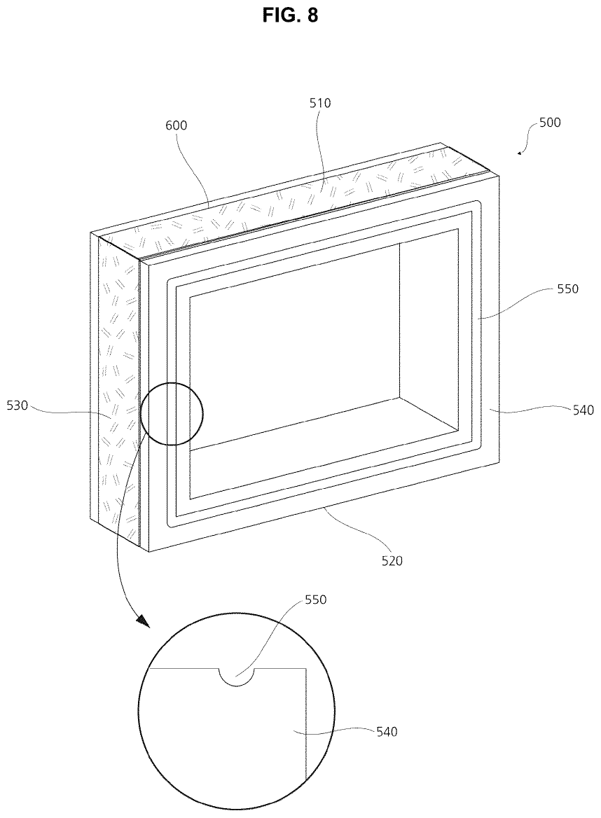

Therefore, according to the present invention, before the temporary inner wall 200 moves to a construction position, as shown in FIG. 8, a filling prevention frame 500 formed in a form that corresponds to an outer edge of the opening 40 is installed to correspond to the outer edge of the opening 40.

In this case, strip-shaped wallpaper 600 is attached to surfaces of the outer edges 510 to 540 of the filling prevention frame 500 to finish an edge portion of the opening 40 and facilitate separation of the filling prevention frame 500 by preventing the filling prevention frame 500 from being in contact with the heat-insulating foamed resin 400.

Also, the wallpaper 300, which is adsorbed on the side plate 220 of the temporary inner wall 200, is attached to the front surface of the filling prevention frame 500. Although there is a need to cut the wallpaper 300, it may be difficult to clearly identify a boundary line. Therefore, according to the present invention, a guide groove 550 for cutting the wallpaper 300 is formed in the front surface of the filling prevention frame 500, thereby facilitating cutting of the wallpaper 300.

Embodiments of the present invention have been described above, but it should be understood by those skilled in the art that various changes and modifications may be made therein by addition, substitution, or removal of components without departing from the spirit and scope of the present invention as defined by the appended claims. Such changed and modified embodiments are also included within the scope of the appended claims.

For example, each component described as a single type may be implemented in a distributed manner, and likewise, components that are described as being distributed may be implemented in a combined form. The scope of the present invention is defined not by the detailed description but by the appended claims, and encompasses all modifications or alterations derived from meanings, the scope and equivalents of the appended claims.

### INDUSTRIAL APPLICABILITY

The present invention relates to a method of constructing an inner wall of a modular house to simultaneously perform construction of insulation materials for insulation and wallpapering work when an inner wall of a modular house is constructed. By using the method according to the present invention, constructability can be improved, a construction period can be shortened, and construction costs can be reduced by simultaneously performing the insulation material construction and the wallpapering work.

1. A method of constructing an inner wall of a modular house with a rectangular parallelepiped exterior, the method comprising:
step (A) of installing a temporary inner wall in a container framework;
step (B) of filling a space between a wall of the container framework and the temporary inner wall with a heat-insulating foamed resin and curing the heat-insulating foamed resin; and
step (C) of moving the temporary inner wall along the wall of the container framework and repeating steps (A) and (B).

2. The method of claim 1, wherein the container framework, which is formed with an additional opening for access and lighting in a standardized container box, includes:
a quadrangular floor;
a quadrangular ceiling facing the floor; and
side walls vertically connecting the floor and the ceiling.

3. The method of claim 2, wherein the temporary inner wall, which is installed at a predetermined distance from the ceiling and the side walls when installed in the container framework, includes:
a top plate formed shorter than a width of the ceiling by a predetermined length;
a pair of side plates formed downward from an end of the top plate to face a longitudinal side wall and formed shorter than a height of the longitudinal side wall by a predetermined length; and
a finishing plate which finishes one end of a structure formed by the top plate and the pair of side plates.

4. The method of claim 3, wherein each of the top plate, the side plates, and the finishing plate includes a plurality of rectangular connecting pieces, and
the plurality of rectangular connecting pieces are foldably connected by a rotating shaft installed between adjacent connecting pieces.

5. The method of claim 3, wherein each of the top plate, the side plates, and the finishing plate includes a plurality of rectangular connecting pieces, and
the plurality of rectangular connecting pieces have insertion protrusions formed at one longitudinal face and insertion grooves formed at the other face, allowing the plurality of rectangular connecting pieces to be inserted and connected to each other.

6. The method of claim 4, wherein step (A) includes:
step (A1) of constructing a temporary inner wall using the connecting pieces in the container framework in a constructed form;
step (A2) of bringing wallpaper into close contact with an outer surface of the temporary inner wall; and
step (A3) of moving the temporary inner wall to a construction position.

7. The method of claim 6, wherein each of the top plate, the side plates, and the finishing plate includes an adsorption hole for adsorbing the wallpaper.

8. The method of claim 7, wherein step (A2) includes:
step (A21) of placing wallpaper on the top plate, the side plates, and the finishing plate; and
step (A22) of connecting an air pump to the adsorption holes and adsorbing the wallpaper onto the top plate, the side plates, and the finishing plate.

9. The method of claim 8, wherein step (B) includes:
step (B1) of positioning pipes for filling one ends between the side walls and the ceiling of the container framework and the wallpaper with a heat-insulating foamed resin;
step (B2) of filling the space between the side walls and the ceiling of the container framework and the wallpaper with the heat-insulating foamed resin while moving the pipe for filling a heat-insulating foamed resin from the one end to the other end; and
step (B3) of curing the heat-insulating foamed resin for a predetermined time after the filling is completed.

10. The method of claim 9, wherein the heat-insulating foamed resin is composed of 20 to 50% by weight of a phenolic resin, 1 to 10% by weight of a surfactant, 10 to 40% by weight of a melamine compound, 0.1 to 5% by weight of a foaming accelerator, 20 to 40% by weight of a flame retardant, and 10 to 20% by weight of a solvent.

11. The method of claim 10, wherein the flame retardant includes a halogenated flame retardant.

12. The method of claim 6, wherein the temporary inner wall is installed at a distance of 5 to 15 cm from the ceiling and the side walls.

13. The method of claim 6, wherein step (A) further includes, before moving the temporary inner wall to a construction position in step (A3), installing a filling prevention frame that corresponds to an outer edge of the opening and prevents the opening from being filled with the heat-insulating foamed resin.

14. The method of claim 13, wherein, when the filling prevention frame is installed, strip-shaped wallpaper for finishing an edge portion of the opening is attached to an outer edge surface of the filling prevention frame to prevent the filling prevention frame from being in contact with the heat-insulating foamed resin so that separation of the filling prevention frame is easy.

15. The method of claim 5, wherein step (A) includes:
step (A1) of constructing a temporary inner wall using the connecting pieces in the container framework in a constructed form;
step (A2) of bringing wallpaper into close contact with an outer surface of the temporary inner wall; and
step (A3) of moving the temporary inner wall to a construction position.
